(19) United States
(12) Patent Application Publication
(10) Pub. No.: US 2008/0051683 A1
(43) Pub. Date: Feb. 28, 2008

(54) Chair type massager

(75) Inventors: Takayoshi Tanizawa, Kadoma-shi (JP); Satoshi Kajiyama, Kadoma-shi (JP); Masamichi Miyaguchi, Kadoma-shi (JP); Daisuke Tsukada, Kadoma-shi (JP); Fumihiro Nishio, Kadoma-shi (JP); Takeo Iijima, Kadoma-shi (JP); Yuichi Nishibori, Kadoma-shi (JP)

Correspondence Address: BACON & THOMAS, PLLC, 625 SLATERS LANE, FOURTH FLOOR, ALEXANDRIA, VA, 22314, US

(73) Assignee: Matsushita Electric Works, Ltd., Kadoma-shi (JP)

(21) Appl. No.: 11/892,573

(22) Filed: Aug. 24, 2007

(30) Foreign Application Priority Data
Aug. 28, 2006 (JP) 2006-231358

(51) Int. Cl. A61H 7/00

(52) U.S. Cl. 601/86

(57) ABSTRACT

A massager includes a main body provided with a treating element movable to a plurality of parts to be treated. A part selecting unit allows a user to select a desired one among parts to be treated. A control unit controls the treating element to move to the to-be-treated part selected by using the part selecting unit and to perform a massage operation which is pre-stored corresponding to the part to be treated.

### FIELD OF THE INVENTION

The present invention relates to a massager which performs a massage by moving a treating element to a specific part to be treated.

### BACKGROUND OF THE INVENTION

Conventionally, a massager performs a preferred massage by selecting a desired massage operation, such as finger-pressure massage (shiatsu) or punching and rubbing massage by a user and adjusting the vertical position of a treating element. However, recently-provided massagers are multi-functionalized and the number of types of selectable massage operation has increased. Accordingly, since too many buttons are positioned in a manipulation unit, the convenience in use is deteriorated and it is difficult for users to select appropriate buttons. That is, although there are provided the optimum massage operation effective for parts to be treated, such as neck, shoulder and the like, it is unreasonable to expect for users to have preliminary knowledge about the optimum operations for parts to be treated. Consequently, a user who does not have relevant preliminary knowledge cannot have a massage performed on by the optimum massage operations.

Moreover, when adjusting a position of the treating element, the user needs to operate the massager to move the treating element in up/down, left/right and back/forth directions so that the treating element is positioned at a desired position. Therefore, the user would have troublesome work to operate the massager.

To solve the aforementioned problems, for example, Japanese Patent Laid-Open Application No. 2002-369855 suggests a massager capable of performing a predetermined treating course after designating approximate positions arranged vertically. In this case, although it is simple to operate the massager, an optimum operation for a user's desired part to be massaged is not ensured.

### SUMMARY OF THE INVENTION

The present invention provides a massager which is capable of performing a massage by using an optimum operation for a part to be massaged, without requiring a user for any complicate button operation or any preliminary knowledge.

In accordance with an aspect of the present invention, there is provided a massager including a main body provided with a treating element movable to a plurality of parts to be treated; a part selecting unit for selecting a desired one among the parts to be treated; and a control unit for controlling the treating element to move to the to-be-treated part selected by using the part selecting unit, and to perform a massage operation which is pre-stored corresponding to the part to be treated. In the massager having the aforementioned configuration, once the user inputs information on a desired part to be treated, such as the neck, shoulder or the like by using the part selecting unit, the control unit receiving the information on the desired part to be treated moves the treating element to the desired part to be treated and simultaneously performs the massage operation which is stored corresponding to the part to be treated. That is, the user may only input information on the part to be treated by using the part selecting unit so that the user can perform a massage by the optimum massage operation for the desired part to be treated without performing complicate operation based on preliminary knowledge. Therefore, the user's effort is reduced and the user can enjoy different types of massage corresponding to the parts to be treated.

Here, the control unit may preferably store the massage operations which are different from one another depending on the parts to be treated. For example, a “neck”, “shoulder”, “back” and “waist”, i.e., the parts to be treated respectively correspond to “shiatsu”, “massage”, “lymph (lymph massage)” and “body correction”, i.e., the massage operations. Therefore, the most effective massage operations for each of the parts to be treated are set.

In the present invention, there is further provided a massager which includes a main body provided with a treating element movable to a plurality of parts to be treated; a part selecting unit for selecting a desired one among the parts to be treated; an operation selecting unit for selecting a desired one among a plurality of massage operations; and a control unit for controlling the treating element to move to the part selected by using the part selecting unit, and to perform the massage operation selected by using the operation selecting unit based on an movement path which is stored corresponding to the part to be treated. In the massager of the above-mentioned configuration, a user inputs information on a desired part to be treated by using the part selecting unit and inputs a massage operation by using the operation selecting unit without performing complicate operation based on preliminary knowledge. Accordingly, the user may perform a massage by a massage operation having an optimum movement path corresponding to the desired part to be treated. Therefore, the user's effort is reduced and the user can enjoy different types of massage depending on the parts to be treated.

Here, the part selecting unit and the operation selecting unit may preferably be united by sharing one group of buttons. Accordingly, even if many parts to be treated or many massage operations are provided, the structure of the selecting unit is prevented from becoming large or heavy.

Further, the part selecting unit may desirably include a whole body selecting button for selecting all parts to be treated at once. Therefore, when a user wants to select all parts to be treated for performing, e.g., a backbone stretch from the neck to the waist, the user may press only one button, i.e., the whole body selecting button, thereby making it very easy to operate the massager. Furthermore, since only one button is added, there is no problem in that the selecting unit becomes large and heavy.

The massagers in accordance with the embodiments of the present invention performs massages by using the optimum massage operations for the desired parts to be treated, without requiring a user for any complicate button operation or preliminary knowledge.

### BRIEF DESCRIPTION OF THE DRAWINGS

The above and other objects and features of the present invention will become apparent from the following description of preferred embodiments given in conjunction with the accompanying drawings, in which:

FIG. 1 is a front view of a manipulation unit of a massager in accordance with a first embodiment of the present invention;

FIG. 2 is a general perspective view of the massager in accordance with the first embodiment of the present invention;

FIG. 3 is a control block diagram of the massager in accordance with the first embodiment of the present invention;

FIG. 4 is a front view of a manipulation unit of a massager in accordance with another embodiment of the present invention;

FIG. 5 is a view for explaining movement paths corresponding to parts to be treated by the massager in accordance with a second embodiment of the present invention;

FIG. 6 is a front view of a manipulation unit of a massager in accordance with a third embodiment of the present invention; and

FIG. 7 is a front view of a manipulation unit of a massager in accordance with a fourth embodiment of the present invention.

### DETAILED DESCRIPTION OF THE EMBODIMENTS

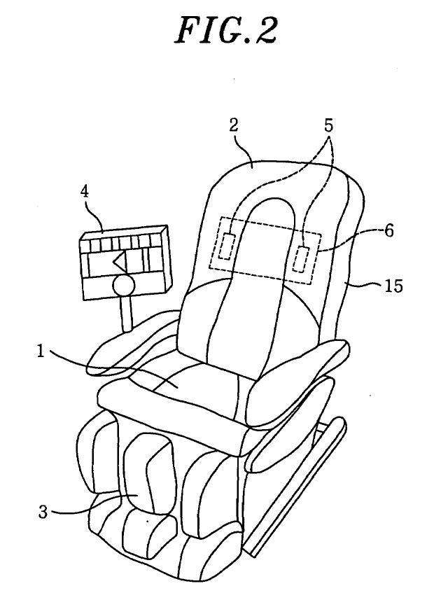

Hereinafter, exemplary embodiments of the present invention will be described in detail with reference to the accompanying drawings. FIG. 2 schematically illustrates a general view of a massager in accordance with an embodiment of the present invention. The massager includes, as a main elements of a massager body 15, a seat part 1 on which a user (not shown) sits, a backrest part 2 against which the user sitting on the seat part 1 leans back, and a footrest unit 3 which holds the feet of the user sitting on the seat unit 1. A movable block 6 is placed in the backrest part 2 so as to be movable up and down. The movable block 6 is provided with a pair of right and left treating elements 5 protruded toward the user.

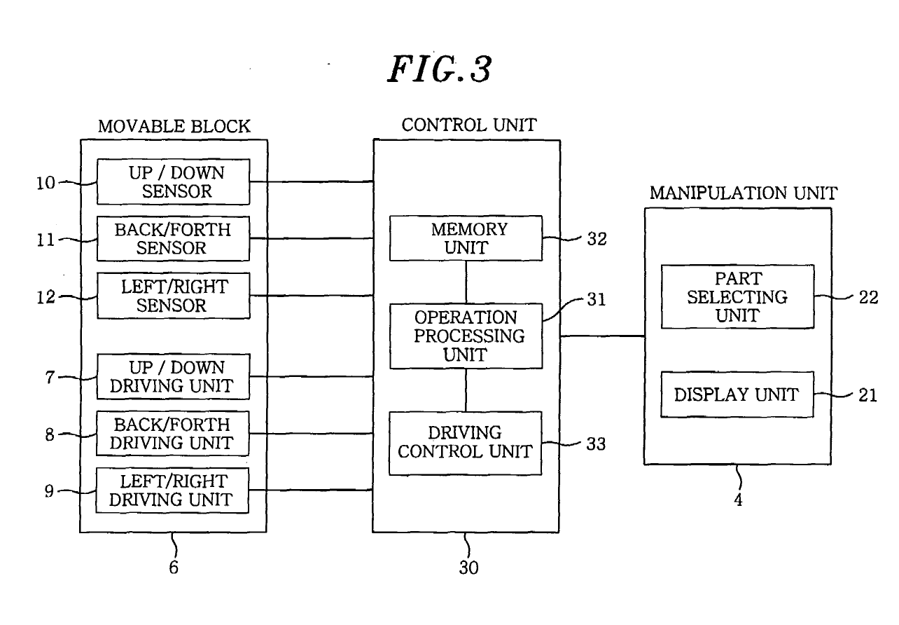

Further, as shown in the block diagram of FIG. 3, the movable block 6 includes a up/down driving unit 7 that drives the whole movable block 6 in a up/down direction, a back/forth driving unit 8 that freely changes a protruding extent of the treating elements 5 in a forward direction by controlling the position of the treating elements 5 in the movable block 6, and a left/right driving unit 9 that allows the pair of right and left treating elements 5 to move closer to each other or separated apart from each other within the movable block 6. The movable block 6 further includes an up/down sensor 10, a back/forth sensor 11 and a left/right sensor 12 to respectively sense the up/down position, back/forth position, and left/right position of the treating elements 5. The configuration of the movable block 6 will not be further described since it is basically same as that described in Japanese Patent Laid-Open Application No. 2006-34635. In addition, another mechanism capable of driving the treating elements 5 to move in the vertical and width directions and control the strength may be used instead of the movable block 6.

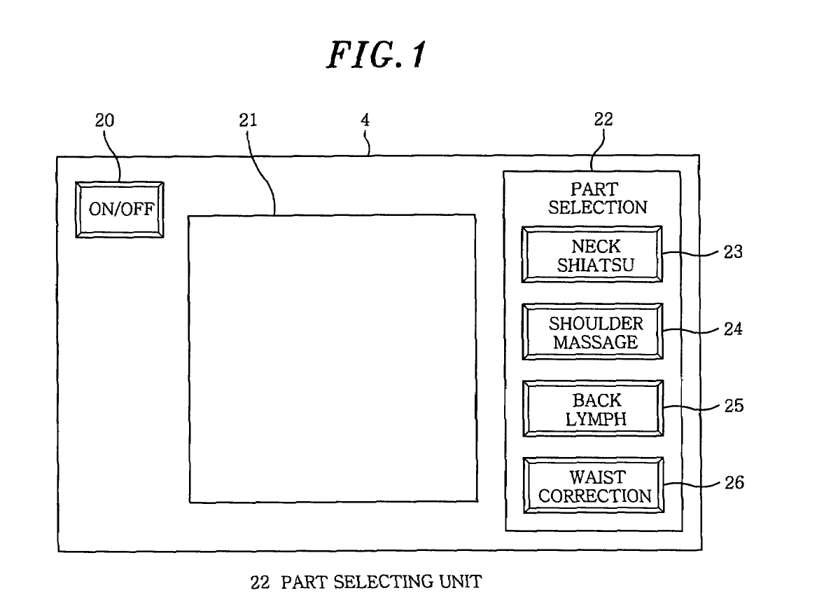

A manipulation unit 4 is extended and protrudes from the massager body 15 so that a user can input various instructions. As illustrated in FIG. 1, the manipulation unit 4 has an on/off button 20 that starts operations, a display unit 21 that displays treatment contents, and a part selecting unit 22 that allows a user to select a desired part to be treated among a plurality of parts to be treated, such as the neck, shoulder, back and waist. The part selecting unit 22 includes buttons arranged vertically in a row, to be specific, a neck selecting button 23, a shoulder selecting button 24, a back selecting button 25 and a waist selecting button 26 respectively corresponding to the parts to be treated, specifically, such as the neck, shoulder, back and waist.

Further, a control unit 30 is provided in the massager body 15 to operate the treating elements 5 based on the instructions inputted through the manipulation unit 4. As illustrated in FIG. 3, the control unit 30 includes an operation processing unit 31 containing an MPU (Micro Processing Unit), a memory unit 32 that stores various data, and a driving control unit 33 that controls the operation of each of the driving units 7, 8 and 9, and the control unit 30 is connected to the manipulation unit 4 and the movable block 6.

The memory unit 32 stores up/down, back/forth and left/right positions of the treating elements 5 corresponding to the parts to be treated, such as the neck, shoulder, back and waist; and types of massage operations corresponding to the parts to be treated. The massage operations correspond to various treatments, such as finger-pressure massage (shiatsu), punching and rubbing massage, lymph (lymph massage) and body correction. The treating elements 5 can be made to move along desired paths by combining the operations of the driving units 7, 8 and 9 under the control of the driving control unit 33.

In this embodiment, different massage operations respectively corresponding to different parts to be treated are stored in the memory unit 32. That is, as printed on the surfaces of the buttons 23, 24, 25 and 26 as shown in FIG. 1, the “neck”, “shoulder”, “back” and “waist”, i.e., the parts to be treated, respectively correspond to the “shiatsu”, “massage”, “lymph (lymph massage)” and “body correction”, i.e., the massage operations.

These massage operations are quite often performed onto the relevant parts to be treated by actual massagists. That is, the shiatsu that can intensively relax the muscles of the nape of the neck is effective for a neck, the massage is effective for shoulders, and the lymph (lymph massage), a type of soft massage is effective for a back since the difference between individuals in a mass of back muscles is great, and the body correction that extends muscles by stretching exercise is effective for a waist. However, massage operations other than those shown in the present embodiment may be set for respective parts to be treated instead. Further, if any other massage operations are effective for some parts to be treated, the massage operations may not necessarily be different depending on the parts to be treated.

In the massager having the above-described configuration, a user sitting on the seat part 1 and leaning against the backrest part 2 presses the on/off button 20 in the manipulation unit 4 to start operation, and then selects and presses one of the buttons 23, 24, 25 and 26 in the part selecting unit 22 corresponding to a desired part to be treated. The operation processing unit 31 in the control unit 30 receives the information on the desired part to be treated which is inputted by selecting one of the buttons of the manipulation unit 4. The operation processing unit 31 recalls from the memory unit 32 the up/down, back/forth and left/right positions of the treating elements 5 that are stored corresponding to the desired part to be treated, and the operation processing unit 31 controls the driving units 7, 8 and 9 by the driving control unit 33 so that the treating elements 5 move to the desired positions, respectively. Thereafter, the positions of the treating elements 5 are detected by the sensors 10, 11 and 12.

That is, the operation processing unit 31 retrieves the type of the massage operation corresponding to the part to be treated which is inputted by selecting the button of the manipulation unit 4, from the memory unit 32 so that the driving control unit 33 can control the driving units 7, 8 and 9 to move the treating element 5 to positions corresponding to the desired part to be treated to make it perform the massage operations.

Therefore, by simply pressing any one of the buttons 23, 24, 25 and 26 of the part selecting unit 22, the user can operate the massager to perform a desired massage by the optimum massage operation depending on the part to be treated, without any complicate button operation and any preliminary knowledge. Accordingly, the user's bothersome work is reduced and the user can enjoy different types of massages depending on parts to be treated.

Further, a plurality of massage operations corresponding to a part to be treated may be stored, and when a desired part to be treated is selected, the plurality of massage operations may be performed sequentially. In this case, it is desirable to have a different massage operation as a first one set to be performed for each different part to be treated.

Next, a massager in accordance with a second embodiment of the present invention will be described. The basic configuration of the massager in this embodiment is the same as that of the massager in the aforementioned first embodiment. Thus, like parts are represented by like reference numerals and detailed description thereof will be omitted.

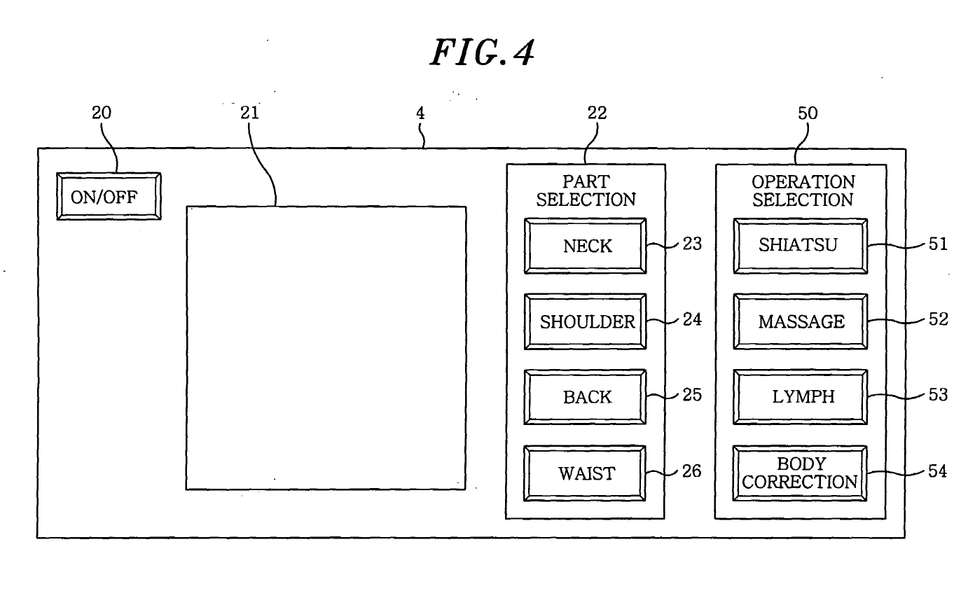

As illustrated in FIG. 4, a manipulation unit 4 includes an operation selecting unit 50 in addition to a part selecting unit 22. The operation selection unit 50 enables an input of desired massage operations among a plurality of massage operations. The massage operations are variety types of treatment actions, such as shiatsu, massage, lymph and body correction. The actions of the driving units 7, 8 and 9 are combined by a driving control unit 33, thereby enabling treating elements 5 to draw corresponding movement paths. In the operation selecting unit 50, specifically, a shiatsu selecting button 51, a massage selecting button 52, a lymph selecting button 53 and a body correction selecting button 54 are vertically positioned in a row, respectively corresponding to the massage operations, such as the shiatsu, massage, lymph and body correction.

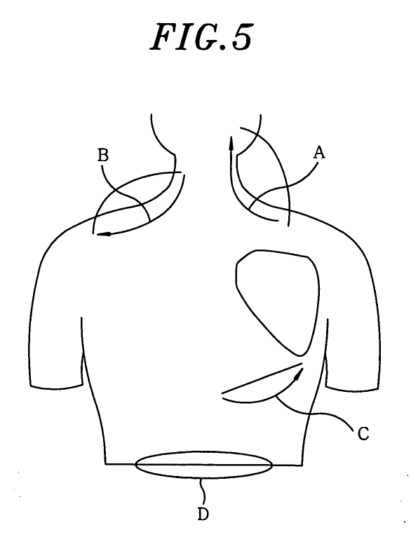

A memory unit 32 stores the movement paths and operation times corresponding to respective parts to be treated in each massage operation, in addition to the up/down, back/forth and left/right positions of the treating elements 5 for the respective parts to be treated. For example, in case of performing the lymph massage, as shown in FIG. 5, for the “neck”, the lymph massage is performed from the top of the shoulder upward, along the nape of the neck, so that the bloodstream easily flows to the brain (see arrow “A”); for the “shoulder”, the lymph massage is performed from the lower part of the neck to the lower part of the arm (see arrow “B”); for the “back”, the lymph massage is performed from the lower lymph duct by pushing up the lymph under the scapula (see arrow “C”); and for the “waist”, the lymph massage is performed across the muscular fibers extending to the spine direction (see arrow “D”). That is, the movement path and the operation time varies depending on the part to be treated, and therefore, storing the optimum movement path and operation time are individually stored for each part to be treated. The optimum movement path or operation time may be the same as those done by a human massagist. In addition to the operation path and operation time, a treatment speed may be stored for each part to be treated.

In the massager having the above-described configuration, a user sitting on a seat part 1 and leaning against a backrest part 2 presses an on/off button 20 of the manipulation unit 4 to start operation. Then the user selects and presses one of the buttons 23, 24, 25 and 26 in the part selecting unit 22 corresponding to a desired part to be treated, and selects and presses one of the buttons 51, 52, 53 and 54 of the operation selecting unit 50 corresponding to a desired massage operation.

The operation processing unit 31 receives the information on the desired part to be treated and the massage operation which are inputted by manipulating the buttons of the manipulation unit 4 so that the driving control unit 33 can control the driving units 7, 8, and 9 to move the treating element 5 to the up/down, back/forth, left/right positions that are stored corresponding to the input part to be treated to make it perform the massage operation based on the movement path and operation time. The movement path and operation time are stored in the memory unit 32 corresponding to the part to be treated and the massage operation.

That is, by simply pressing any one of the buttons 23, 24, 25 and 26 of the part selecting unit 22, and any one of the buttons 51, 52, 53 and 54 of the operation selecting unit 50, the user can operate the massager to perform the massage operation to each desired part to be treated in the optimum movement path and operation time without any complicate button operation and any preliminary knowledge. Therefore, the user's bothersome work is reduced and the user can enjoy various massages depending on parts to be treated.

Next, a massager in accordance with a third embodiment of the present invention will be described. The basic configuration of the massager in this embodiment is the same as that of the massager in the first embodiment. Thus, like parts are represented by like reference numerals and detailed description thereof will be omitted.

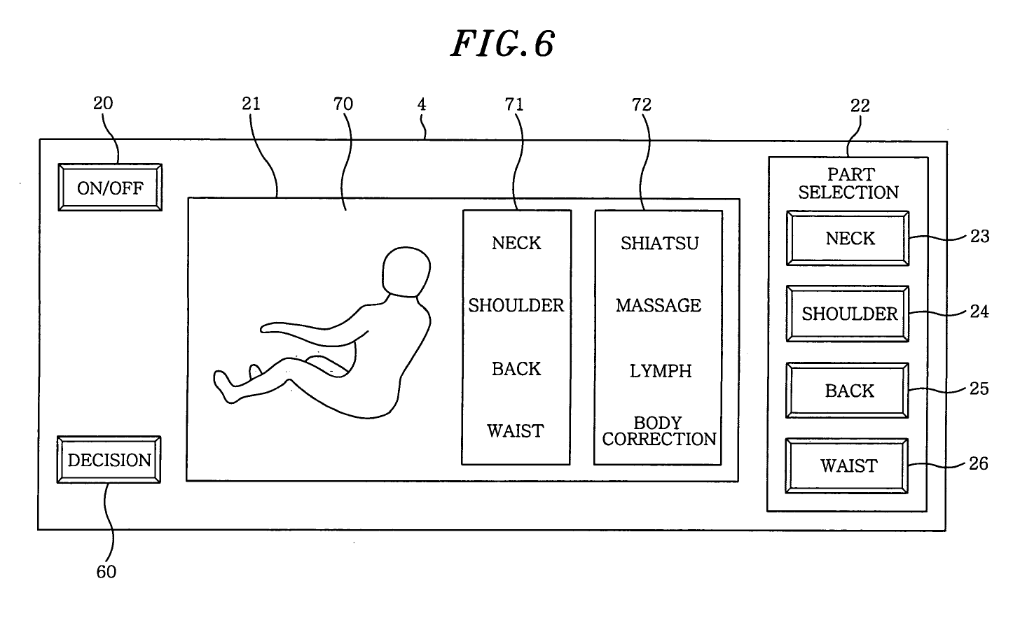

The feature of this embodiment is that a group of the buttons in the part selecting unit 22 and a group of the buttons in the operation selecting unit 50 which are positioned in the manipulation unit 4 in the other embodiments are united in a group of the same buttons. Specifically, as illustrated in FIG. 6, a manipulation unit 4 includes an on/off button 20, a display unit 21 formed of a fluorescent display tube, a part selecting unit 22 wherein a neck selecting button 23, a shoulder selecting button 24, a back selecting button 25 and a waist selecting button 26 are provided vertically in a row, and a decision button 60.

The display unit 21 includes, in separate frames, a treatment contents display unit 70 that displays treatment contents, a part display unit 71 that displays parts to be treated, such as neck, shoulder, back and waist, and a massage operation display unit 72 that displays types of massage operations, such as shiatsu, massage, lymph and body correction. The display unit 21 may use an LED and the like for displaying.

In the massager having the above-described configuration, a user sitting on the seat part 1 and leaning against the backrest part 2 presses the on/off button 20 in the manipulation unit 4 to start operation, and then selects and presses one of the buttons 23, 24, 25 and 26 in the part selecting unit 22 corresponding to a desired part to be treated. To make the user easily understand the operational sequence, a character marked portion of the part display unit 71 in the display unit 21 flickers. When the user presses one of the buttons 23, 24, 25 and 26, the character marked portion corresponding to the selected part to be treated is lighted, thereby notifying the user that the part to be treated is selected. The character marked unit of the massage operation display unit 72 starts flickering after the part to be treated is selected. When the user re-presses the selected one of the buttons 23, 24, 25 and 26, only the “shiatsu”, which is positioned at the top of the character marked portion of the massage operation display unit 72 is converted to be lighted and the lights of the others are off. Further, when re-pressing the selected button, the “shiatsu” is off, the following “massage” is on.

That is, the massage operations are converted in turn, for example, “shiatsu”→“massage”→“lymph massage”→“body correction”, by repeatedly and continuously pressing the first selected one among the buttons 23, 24, 25 and 26 of the part selecting unit 22. Accordingly, the massage operation being selected at the present is displayed on the display unit 21 and simultaneously the massage operation is confirmed by pressing the decision button 60 when the desired massage operation is selected. Consequently, a massage operation massage operation can be selected by using the part selecting unit 22 only.

In the above-described configuration, the massager can be prevented from becoming large in size and heavy in weight, by reducing the number of buttons of the manipulation unit 4. Furthermore, the user can easily understand the operating method by the guidance of the display unit 21.

Next, a massager in accordance with a fourth embodiment of the present invention will be described. The basic configuration of the massager in this embodiment is the same as that of the massagers in the first embodiment. Thus, like parts are represented by like reference numerals and detailed description thereof will be omitted.

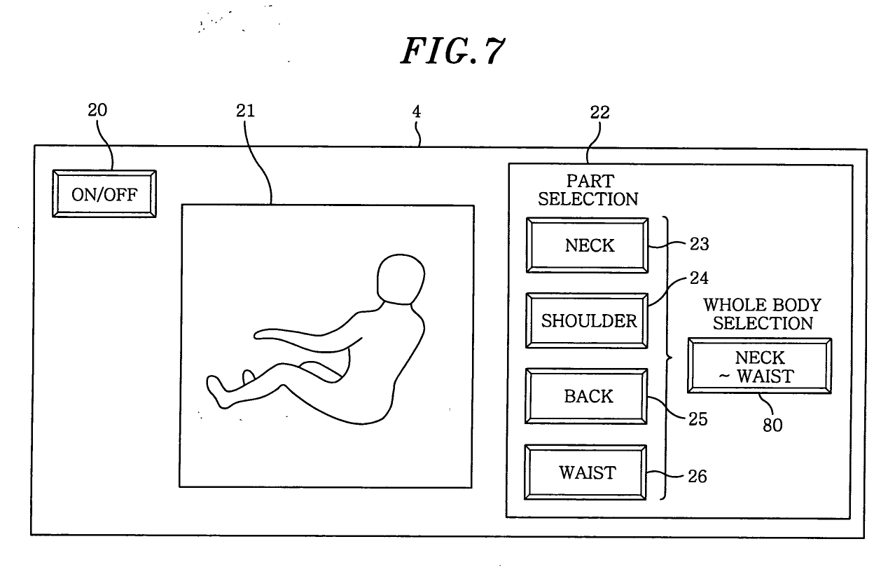

As illustrated in FIG. 7, a massager is characterized by including a whole body selecting button 80 that selects all parts to be treated at once in a part selecting unit 22 provided in a manipulation unit 4. With this, when a user wants to select all parts to be treated, for example, the backbone line from the neck to the waist, the user may press only one button, i.e., the whole body selecting button 80, thereby making it very easy to operate the massager. Furthermore, since only one button is added, there is no problem in that the manipulation unit 4 becomes larger and heavier.

While the invention has been shown and described with respect to the preferred embodiments, it will be understood by those skilled in the art that various changes and modifications may be made without departing from the scope of the invention as defined in the following claims.

What is claimed is:

1. A massager comprising:
a main body provided with a treating element movable to a plurality of parts to be treated;
a part selecting unit for selecting a desired one among the parts to be treated; and
a control unit for controlling the treating element to move to the to-be-treated part selected by using the part selecting unit, and to perform a massage operation which is pre-stored corresponding to the part to be treated.

2. The massager of claim 1, wherein the control unit stores different types of massage operations corresponding to the parts to be treated.

3. A massager comprising:
a main body provided with a treating element movable to a plurality of parts to be treated;
a part selecting unit for selecting a desired one among the parts to be treated;
an operation selecting unit for selecting a desired one among a plurality of massage operations; and
a control unit for controlling the treating element to move to the part selected by using the part selecting unit, and to perform the massage operation selected by using the operation selecting unit based on an movement path which is stored corresponding to the part to be treated.

4. The massager of claim 3, wherein the part selecting unit and the operation selecting unit are united in a group of same buttons.

5. The massager of claim 1, wherein the part selecting unit includes a whole body selecting button for selecting all parts to be treated at once.

6. The massager of claim 2, wherein the part selecting unit includes a whole body selecting button for selecting all parts to be treated at once.

7. The massager of claim 3, wherein the part selecting unit includes a whole body selecting button for selecting all parts to be treated at once.

8. The massager of claims 4, wherein the part selecting unit includes a whole body selecting button for selecting all parts to be treated at once.
